(19) United States
(12) Patent Application Publication
(10) Pub. No.: US 2026/0112382 A1
(43) Pub. Date: Apr. 23, 2026

(54) ELECTRONIC DEVICE AND METHOD FOR PROCESSING SIGNAL INCLUDING VOICE

(71) Applicant: SAMSUNG ELECTRONICS CO., LTD., Suwon-si (KR)

(72) Inventors: Geeyeun KIM, Suwon-si (KR); Hangil MOON, Suwon-si (KR); Kyoungho BANG, Suwon-si (KR); Jaemo YANG, Suwon-si (KR); Gunwoo LEE, Suwon-si (KR); Soonho BAEK, Suwon-si (KR)

(21) Appl. No.: 19/390,335

(22) Filed: Nov. 14, 2025

Related U.S. Application Data
(63) Continuation of application No. PCT/KR2024/004038, filed on Mar. 29, 2024.

(30) Foreign Application Priority Data
Jun. 7, 2023 (KR) 10-2023-0072880
Jun. 30, 2023 (KR) 10-2023-0085024

(51) Int. Cl. G10L 21/0232; G10L 21/0216; G10L 25/18; G10L 25/30

(52) U.S. Cl. CPC G10L 21/0232; G10L 25/18; G10L 25/30; G10L 2021/02166

(57) ABSTRACT

This wearable device may comprise: a memory for storing instructions; a plurality of microphones; an accelerometer; and at least one processor. When executed individually or collectively by the at least one processor, the instructions cause the wearable device to: acquire, on the basis of encoding layers of a neural network, first feature values from a first voice signal acquired through an outer microphone of the plurality of microphones; acquire, on the basis of an embedding layer connected to a bottleneck layer of the neural network, second feature values from at least one voice signal from among the first voice signal, a second voice signal acquired through an inner microphone of the plurality of microphones, and a third voice signal acquired through the accelerometer; and acquire, on the basis of decoding layers of the neural network, a noise-suppressed signal from the first feature values and the second feature values.

### CROSS-REFERENCE TO RELATED APPLICATIONS

This application is a continuation application of International Application No. PCT/KR2024/004038 designating the United States, filed on Mar. 29, 2024, in the Korean Intellectual Property Receiving Office and claiming priority to Korean Patent Application No. 10-2023-0072880, filed on Jun. 7, 2023, and Korean Patent Application No. 10-2023-0085024, filed on Jun. 30, 2023, in the Korean Intellectual Property Office, the disclosures of which are incorporated by reference in their entireties.

### BACKGROUND

The following descriptions relate to an electronic device and a method for processing a signal including voice.

An electronic device may include a wearable device that may be worn by a user. For example, the wearable device may be worn at or in an ear of the user.

The electronic device may include a neural network. For example, the electronic device may process a signal including voice obtained from the outside based on the neural network. Accordingly, the electronic device may obtain a signal in which the voice is enhanced.

### SUMMARY

According to an embodiment, a wearable device is provided. The wearable device may include a plurality of microphones. The wearable device may include an accelerometer. The wearable device may include a processor. The processor may be configured to, based on encoding layers of a neural network, obtain first feature values from a first voice signal obtained via an outer microphone of the plurality of microphones. The processor may be configured to, based on an embedding layer connected to a bottleneck layer of the neural network, obtain second feature values from at least one voice signal from among the first voice signal, a second voice signal obtained via an inner microphone of the plurality of microphones, and a third voice signal obtained via the accelerometer. The at least one voice signal may be identified based on a signal to noise ratio (SNR) of the first voice signal. The processor may be configured to, based on decoding layers of the neural network, obtain a signal in which a noise is suppressed from the first feature values and the second feature values.

According to an embodiment, a wearable device is provided. The wearable device may include a plurality of microphones. The wearable device may include a sensor. The wearable device may include a processor. The processor may be configured to, based on first layers from among a plurality of layers of a neural network, obtain first feature values from a first voice signal obtained via an outer microphone of the plurality of microphones. The processor may be configured to, based on at least one second layer including a second output layer connected to a first output layer of the first layers, obtain second feature values from at least one voice signal from among the first voice signal, a second voice signal obtained via an inner microphone of the plurality of microphones, and a third voice signal obtained via the sensor. The at least one voice signal may be identified based on a quality of the first voice signal. The processor may be configured to, based on third layers including an input layer connected to the first output layer among the plurality of layers, obtain a signal in which a noise is suppressed from the first feature values and the second feature values.

### BRIEF DESCRIPTION OF THE DRAWINGS

FIG. 1 is a block diagram of an electronic device in a network environment according to various embodiments.

FIG. 2A illustrates an example of a perspective view of a wearable device.

FIG. 2B illustrates an example of a disassembled view of a wearable device.

FIG. 3 illustrates an example of a block diagram of a wearable device.

FIG. 4 illustrates an example of a neural network for processing a voice signal and an embedding layer connected to the neural network.

FIG. 5 illustrates an example of a method of training an embedding layer and a neural network and inferring based on the embedding layer and the neural network.

FIG. 6 illustrates an example of an operation flow for a method of obtaining a signal in which a noise is suppressed via a trained embedding layer and neural network.

FIG. 7A illustrates an example of an operation flow for a method of identifying at least one voice signal for an embedding layer from a plurality of voice signals.

FIG. 7B illustrates an example of an operation flow for a method of obtaining a feature value via an embedding layer.

FIGS. 8A and 8B illustrate examples of a signal processed via an embedding layer and a neural network.

FIG. 9 illustrates an example of an operation flow for a method of obtaining a signal in which a noise is suppressed via an embedding layer and a neural network.

### DETAILED DESCRIPTION

Terms used in the present disclosure are used only to describe a specific embodiment, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B).

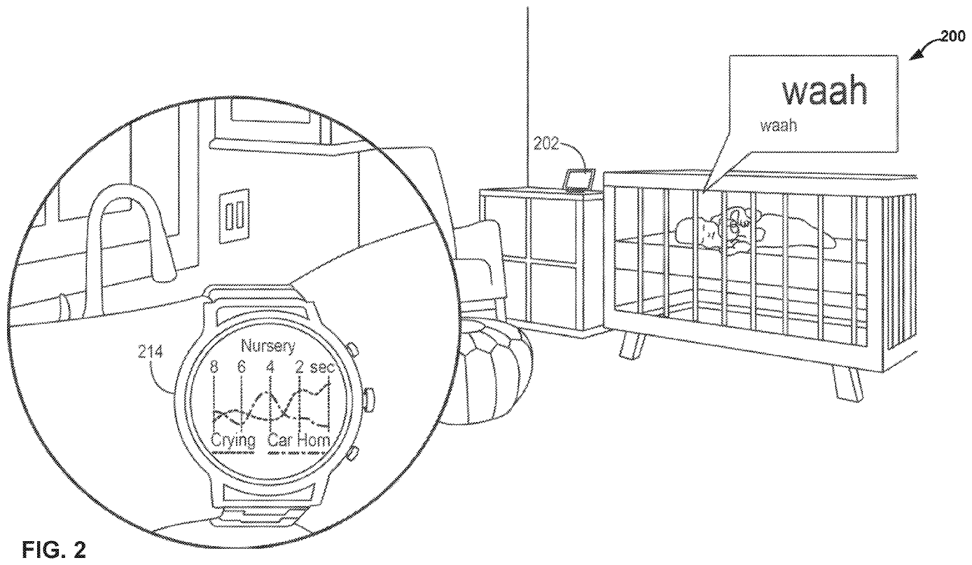

FIG. 2 is a block diagram illustrating an electronic device 201 in a network environment 200 according to various embodiments.

Referring to FIG. 2, the electronic device 201 in the network environment 200 may communicate with an electronic device 202 via a first network 298 (e.g., a short-range wireless communication network), or at least one of an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, memory 230, an input module 250, a sound output module 255, a display module 260, an audio module 270, a sensor module 276, an interface 277, a connecting terminal 278, a haptic module 279, a camera module 280, a power management module 288, a battery 289, a communication module 290, a subscriber identification module(SIM) 296, or an antenna module 297. In some embodiments, at least one of the components (e.g., the connecting terminal 278) may be omitted from the electronic device 201, or one or more other components may be added in the electronic device 201. In some embodiments, some of the components (e.g., the sensor module 276, the camera module 280, or the antenna module 297) may be implemented as a single component (e.g., the display module 260).

The processor 220 may execute, for example, software (e.g., a program 240) to control at least one other component (e.g., a hardware or software component) of the electronic device 201 coupled with the processor 220, and may perform various data processing or computation. According to an embodiment, as at least part of the data processing or computation, the processor 220 may store a command or data received from another component (e.g., the sensor module 276 or the communication module 290) in volatile memory 232, process the command or the data stored in the volatile memory 232, and store resulting data in non-volatile memory 234. According to an embodiment, the processor 220 may include a main processor 221 (e.g., a central processing unit (CPU) or an application processor (AP)), or an auxiliary processor 223 (e.g., a graphics processing unit (GPU), a neural processing unit (NPU), an image signal processor (ISP), a sensor hub processor, or a communication processor (CP)) that is operable independently from, or in conjunction with, the main processor 221. For example, when the electronic device 201 includes the main processor 221 and the auxiliary processor 223, the auxiliary processor 223 may be adapted to consume less power than the main processor 221, or to be specific to a specified function. The auxiliary processor 223 may be implemented as separate from, or as part of the main processor 221.

The auxiliary processor 223 may control at least some of functions or states related to at least one component (e.g., the display module 260, the sensor module 276, or the communication module 290) among the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 223. According to an embodiment, the auxiliary processor 223 (e.g., the neural processing unit) may include a hardware structure specified for artificial intelligence model processing. An artificial intelligence model may be generated by machine learning. Such learning may be performed, e.g., by the electronic device 201 where the artificial intelligence is performed or via a separate server (e.g., the server 208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234.

The program 240 may be stored in the memory 230 as software, and may include, for example, an operating system (OS) 242, middleware 244, or an application 246.

The input module 250 may receive a command or data to be used by another component (e.g., the processor 220) of the electronic device 201, from the outside (e.g., a user) of the electronic device 201. The input module 250 may include, for example, a microphone, a mouse, a keyboard, a key (e.g., a button), or a digital pen (e.g., a stylus pen).

The sound output module 255 may output sound signals to the outside of the electronic device 201. The sound output module 255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 260 may visually provide information to the outside (e.g., a user) of the electronic device 201. The display module 260 may include, for example, a display, a hologram device, or a projector and control circuitry to control a corresponding one of the display, hologram device, and projector. According to an embodiment, the display module 260 may include a touch sensor adapted to detect a touch, or a pressure sensor adapted to measure the intensity of force incurred by the touch.

The audio module 270 may convert a sound into an electrical signal and vice versa. According to an embodiment, the audio module 270 may obtain the sound via the input module 250, or output the sound via the sound output module 255 or a headphone of an external electronic device (e.g., an electronic device 202) directly (e.g., wiredly) or wirelessly coupled with the electronic device 201.

The sensor module 276 may detect an operational state (e.g., power or temperature) of the electronic device 201 or an environmental state (e.g., a state of a user) external to the electronic device 201, and then generate an electrical signal or data value corresponding to the detected state. According to an embodiment, the sensor module 276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, an HDMI connector, a USB connector, an SD card connector, or an audio connector (e.g., a headphone connector).

The haptic module 279 may convert an electrical signal into a mechanical stimulus (e.g., a vibration or a movement) or electrical stimulus which may be recognized by a user via his tactile sensation or kinesthetic sensation. According to an embodiment, the haptic module 279 may include, for example, a motor, a piezoelectric element, or an electric stimulator.

The camera module 280 may capture a still image or moving images. According to an embodiment, the camera module 280 may include one or more lenses, image sensors, image signal processors, or flashes.

The power management module 288 may manage power supplied to the electronic device 201. According to an embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the application processor (AP)) and supports a direct (e.g., wired) communication or a wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device via the first network 298 (e.g., a short-range communication network, such as Bluetooth™, wireless-fidelity (Wi-Fi) direct, or infrared data association (IrDA)) or the second network 299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 292 may identify and authenticate the electronic device 201 in a communication network, such as the first network 298 or the second network 299, using subscriber information (e.g., international mobile subscriber identity (IMSI)) stored in the subscriber identification module 296.

The wireless communication module 292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 292 may support a high-frequency band (e.g., the mmWave band) to achieve, e.g., a high data transmission rate. The wireless communication module 292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 292 may support various requirements specified in the electronic device 201, an external electronic device (e.g., the electronic device 204), or a network system (e.g., the second network 299). According to an embodiment, the wireless communication module 292 may support a peak data rate (e.g., 20 Gbps or more) for implementing eMBB, loss coverage (e.g., 264 dB or less) for implementing mMTC, or U-plane latency (e.g., 0.5 ms or less for each of downlink (DL) and uplink (UL), or a round trip of 2 ms or less) for implementing URLLC.

The antenna module 297 may transmit or receive a signal or power to or from the outside (e.g., the external electronic device) of the electronic device 201. According to an embodiment, the antenna module 297 may include an antenna including a radiating element composed of a conductive material or a conductive pattern formed in or on a substrate (e.g., a printed circuit board (PCB)). According to an embodiment, the antenna module 297 may include a plurality of antennas (e.g., array antennas). In such a case, at least one antenna appropriate for a communication scheme used in the communication network, such as the first network 298 or the second network 299, may be selected, for example, by the communication module 290 (e.g., the wireless communication module 292) from the plurality of antennas. The signal or the power may then be transmitted or received between the communication module 290 and the external electronic device via the selected at least one antenna. According to an embodiment, another component (e.g., a radio frequency integrated circuit (RFIC)) other than the radiating element may be additionally formed as part of the antenna module 297.

According to various embodiments, the antenna module 297 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 201 and the external electronic device 204 via the server 208 coupled with the second network 299. Each of the electronic devices 202 or 204 may be a device of a same type as, or a different type, from the electronic device 201. According to an embodiment, all or some of operations to be executed at the electronic device 201 may be executed at one or more of the external electronic devices 202, 204, or 208. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, mobile edge computing (MEC), or client-server computing technology may be used, for example. The electronic device 201 may provide ultra low-latency services using, e.g., distributed computing or mobile edge computing. In another embodiment, the external electronic device 204 may include an internet-of-things (IoT) device. The server 208 may be an intelligent server using machine learning and/or a neural network. According to an embodiment, the external electronic device 204 or the server 208 may be included in the second network 299. The electronic device 201 may be applied to intelligent services (e.g., smart home, smart city, smart car, or healthcare) based on 5G communication technology or IoT-related technology.

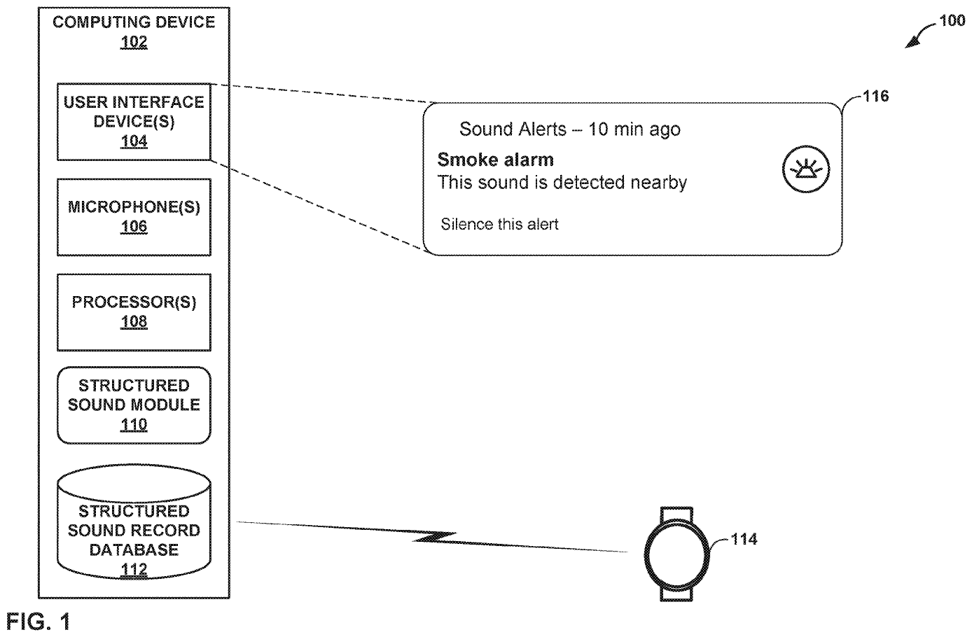

FIG. 2A illustrates an example of a perspective view of a wearable device. FIG. 2B illustrates an example of an exploded view of a wearable device. For example, a wearable device 290 of FIGS. 2A and 2B may indicate an example of the electronic device 101 of FIG. 1.

Referring to FIGS. 2A and 2B, the wearable device 290 may include a case 200 and/or an ear tip 260.

According to an embodiment, the wearable device 290 may be worn at a portion (e.g., a head or an ear) of a body of a user and may provide audio information to the user. For example, the wearable device 290 may provide audio information to the user by inserting a portion into the ear of the user. A partial area of the wearable device 290 including the ear tip 260 may be inserted into the ear of the user and transmit audio information provided from a sound output device disposed inside the wearable device 290 to the user via the ear tip 260. For example, the wearable device 290 may include a true wireless stereo (TWS). According to an embodiment, the wearable device 290 may provide audio information to the user wearing the wearable device 290 based on a signal received from an external device. For example, the wearable device 290 may receive a signal related to audio information from an external electronic device (e.g., a portable communication device (e.g., a smartphone), a computer device, a portable multimedia device, a portable medical device, a camera, another wearable device, or a home appliance). The wearable device 290 may establish a communication channel with an external electronic device, and may receive, from the external electronic device, not only the signal related to the audio information, but also a control signal for controlling the wearable device 290.

According to an embodiment, the wearable device 290 may include a communication module (e.g., the communication module 190 of FIG. 1) for communicating with an external device. The wearable device 290 may control an operation of internal configurations based on a signal received via the communication module. For example, the communication module may be a communication module for Bluetooth, but is not limited thereto. For example, the communication module may communicate with an external electronic device via a short-range communication network. In an embodiment, the wearable device 290 may be connected to an external electronic device by wire. For example, the wearable device 290 may be connected to an interface of an external electronic device via a cable connected to the wearable device 290.

For example, the signal related to the audio information may include a signal related to music or voice to be provided to the user by the wearable device 290. For example, the control signal may include a signal for adjusting sound of the wearable device 290 or requesting an update of software installed on the wearable device 290. For example, the wearable device 290 may receive data for updating software.

The case 200 according to an embodiment may form an outer surface that may be touched by a hand of the user. According to an embodiment, the case 200 may form an inner space 201 in which various configurations of the wearable device 290 may be accommodated. According to an embodiment, the case 200 may include a first case 210 and/or a second case 220. For example, the inner space 201 may be a space surrounded by the first case 210 and the second case 220 by coupling of the first case 210 and the second case 220. The inner space 201 may further include structures (e.g., a bracket) capable of supporting electronic components, which are configurations of the wearable device 290.

According to an embodiment, when the user wears the wearable device 290, the first case 210 may be disposed to face an external auditory canal of the user. According to an embodiment, a terminal hole 211 connecting a terminal 253 and the outside of the wearable device 290 may be formed on a side of the first case 210. The terminal 253 may be exposed to the outside of the first case 210 via the terminal hole 211. According to an embodiment, the first case 210 may include a sensor hole 212 connecting a wearing detection sensor 254 and the outside of the wearable device 290. The wearing detection sensor 254 may be a sensor capable of collecting information that may detect the wearing of the user. The wearing detection sensor 254 may be exposed to the outside of the first case 210 via the sensor hole 212. According to an embodiment, the first case 210 may include a through hole 213 connecting the inner space 201 and the outside of the wearable device 290.

When the user wears the wearable device 290, the second case 220 may be disposed to face a direction opposite to a direction in which the first case 210 is disposed based on a boundary surface between the first case 210 and the second case 220. According to an embodiment, a microphone hole 221 connecting the wearable device 290 and the inner space 201 in which a microphone 240 (e.g., an outer microphone 242) is disposed may be formed on a side of the second case 220. According to an embodiment, the second case 220 may include a touch area configured to detect a touch of the user. The user may control an operation of the wearable device 290 by touching the touch area of the second case 220. For example, the wearable device 290 may include a touch sensor exposed to the outside in the touch area. The touch sensor may receive an external input for controlling the operation of the wearable device 290.

According to an embodiment, the first case 210 and the second case 220 may form the inner space 201 of the case 200 by being coupled to each other. For example, a coupling method of the first case 210 and the second case 220 may be a snap-fit method, a screw coupling method, a magnetic coupling method, or a force fitting method, and the like, but is not limited thereto.

A speaker 230 may receive an electrical signal and output sound or a signal based on the received electrical signal. According to an embodiment, the speaker 230 may be disposed adjacent to the first case 210 to transmit the outputted sound to the outside of the wearable device 290.

The microphone 240 may receive an audio signal and generate an electrical signal based on the received audio signal. For example, the microphone 240 may be a feedback microphone for active noise cancellation (ANC) to cancel a noise. According to an embodiment, the microphone 240 may include an inner microphone 241 disposed to direct the first case 210 and an outer microphone 242 disposed to direct the second case 220. However, an embodiment of the present disclosure is not limited thereto. According to an embodiment, the microphone 240 may include the inner microphone 241 and the outer microphone 242 identified based on a direction in which a voice signal is obtained. For example, the inner microphone 241 may include at least one microphone for obtaining a signal including voice (hereinafter, a voice signal) from a first direction toward a body portion in a state in which the wearable device 290 is worn at the body portion (e.g., the ear) of the user. For example, the outer microphone 242 may include at least one microphone for obtaining a voice signal from a second direction different from the first direction in a state in which the wearable device 290 is worn at the body portion (e.g., the ear) of the user. For example, the at least one microphone included in the outer microphone 242 may include a main mic and a sub mic for obtaining the voice signal from the second direction. For example, the main mic may be used to obtain the voice signal from the second direction. For example, the sub mic may be used in a case that the main mic is not used, in a case that a quality of a voice signal obtained from the main mic is less than or equal to a specified quality, or in order to obtain the voice signal auxiliary with respect to the main mic.

For example, the microphone 240 may be an electronic condenser microphone (ECM) or a micro electro mechanical system (MEMS), and the like, but is not limited thereto. In FIGS. 2A and 2B, three microphones 240 (e.g., two outer microphones 242 and one inner microphone 241) are exemplified, but an embodiment of the present disclosure is not limited thereto. For example, the wearable device 290 may include a larger number of outer microphones or inner microphones than the number of microphones exemplified in FIGS. 2A and 2B. Alternatively, the wearable device 290 may include a smaller number of outer microphones or inner microphones than the number of microphones exemplified in FIGS. 2A and 2B.

According to an embodiment, an electronic component 250 may include a battery 251, a first circuit board 252, the terminal 253, the wearing detection sensor 254, a second circuit board 255, a connection unit 256, and/or an accelerometer 257.

According to an embodiment, the battery 251 may supply power to at least one component of the wearable device 290. For example, the battery 251 may include a non-rechargeable primary battery, a rechargeable secondary battery, or a fuel cell.

According to an embodiment, the first circuit board 252 may be disposed adjacent to the first case 210. For example, the first circuit board 252 may be electrically connected to the speaker 230 and the inner microphone 241.

According to an embodiment, the terminal 253 electrically connecting the battery 251 to an external electronic device may be disposed in the first circuit board 252. The terminal 253 may be disposed in the first circuit board 252 such that a portion passes through the terminal hole 211 formed in the first case 210 and is exposed to the outside of the wearable device 290. For example, an external device connected to the wearable device 290 via the terminal 253 may be a cradle (not illustrated) for supplying power to the battery 251. The terminal 253 may be connected to a terminal of an external device such as the cradle, such as a charging device or a charging case of a wearable device. The terminal 253 may supply power to the wearable device 290 via a terminal of the external electronic device. For example, the power supplied to the wearable device 290 may be used to charge the battery 251. The terminal hole 211 may be formed on a side surface of the wearable device 290 facing a seating surface of the external device when the wearable device 290 is seated on the external device. For example, when the wearable device 290 is seated on a charging case of the wearable device 290 in a specified state, the terminal hole 211 may be formed at a position corresponding to a charging terminal among surfaces in which the wearable device 290 contacts the charging case.

According to an embodiment, the wearing detection sensor 254 configured to detect whether the user wears the wearable device 290 may be disposed in the first circuit board 252. The wearing detection sensor 254 may be disposed in the first circuit board 252 such that a portion passes through the sensor hole 212 formed in the first case 210 and is exposed to the outside of the wearable device 290. The wearing detection sensor 254 may detect contact or approach of a body portion of the user. For example, the wearing detection sensor 254 may detect a case that the wearable device 290 is inserted into the external auditory canal of the user. The wearing detection sensor 254 may mean, for example, a proximity sensor, but is not limited thereto. The wearing detection sensor 254 may include an ultrasonic sensor, an infrared sensor, a touch sensor, or a combination thereof.

According to an embodiment, the second circuit board 255 may be disposed to be spaced apart from the first circuit board 252 and adjacent to the second case 220. For example, the second circuit board 255 may be disposed on another side of the battery 251 facing a side of the battery 251 on which the first circuit board 252 is disposed. According to an embodiment, the second circuit board 255 may be electrically connected to the outer microphone 242. For example, the outer microphone 242 may be disposed in an area of the second circuit board 255 to correspond to a position of the microphone hole 221 of the second case 220. For example, the first circuit board 252 and the second circuit board 255 may be at least one of a printed circuit board (PCB) and a flexible printed circuit board (FPCB).

According to an embodiment, the connection unit 256 may electrically connect the first circuit board 252 and the second circuit board 255. According to an embodiment, the connection unit 256 may surround a portion of a sidewall of the battery 251, and may extend from the first circuit board 252 to the second circuit board 255. The connection unit 256 may be, for example, at least one of a flexible printed circuit board (FPCB) formed of a polyimide material, and a metal wire.

According to an embodiment, the accelerometer 257 may be disposed in the second circuit board 255. For example, the accelerometer 257 may indicate a sensor for measuring vibration or acceleration in relation to the wearable device 290. For example, the accelerometer 257 may measure information on vibration obtained from the body portion (e.g., the ear) of the user. The vibration may be generated as the user utters voice. For example, the accelerometer 257 may generate an electrical signal based on the measured acceleration. For example, the accelerometer 257 may include a shear, flexural, or compression type. For example, the accelerometer 257 may be referred to as a vibration sensor, an acceleration meter, a vibration accelerometer, or a voice pickup unit (VPU).

When the wearable device 290 is worn by the user, the ear tip 260 may adhere to an inner wall of the external auditory canal such that audio outputted from the speaker 230 is smoothly transmitted to the user. In an embodiment, the ear tip 260 may be formed of a silicon material. For example, at least one area of the ear tip 260 may be deformed according to a shape of the ear of the user when the wearable device 290 is worn by the user. For example, the ear tip 260 may be formed by a combination of at least one of silicon, foam, and a plastic material.

An electronic device (e.g., the wearable device 290) may enhance the voice portion of a voice signal obtained from the outside via a speech enhancement scheme. For example, the electronic device may perform the speech enhancement scheme using a neural network. Based on the speech enhancement scheme, the electronic device may provide a service using personalized technology. For example, the service may include speaker registration or speaker identification.

In an example of the speech enhancement scheme, the electronic device may use a signal obtained from an accelerometer (hereinafter, an acceleration signal) and a signal obtained from a microphone (hereinafter, a microphone signal) as an input of the neural network. For example, a sampling rate of the acceleration signal may be approximately 4 kHz, and a sampling rate of the microphone signal may be approximately 16 kHz. The neural network may obtain an output signal based on the acceleration signal and the microphone signal. The electronic device may obtain a signal in which a voice portion is enhanced by comparing the output signal of the neural network with at least a portion of the microphone signal.

In an example of the speech enhancement scheme, the electronic device may input the microphone signal and the acceleration signal to the neural network. For example, the electronic device may obtain a speech reference via the neural network based on the microphone signal and the acceleration signal. In addition, the electronic device may obtain a noise reference by performing voice suppression using the microphone signal and the speech reference as an input. The electronic device may obtain the signal in which the voice portion is enhanced based on the microphone signal, the speech reference, and the noise reference. In addition, the electronic device may obtain SNR information using the signal in which the voice portion is enhanced, the microphone signal, and the noise reference. The electronic device may train the neural network based on the SNR information.

In the examples of the speech enhancement scheme as described above, size of the neural network may be expanded, as a processing (e.g., interpolation) for adjusting the sampling rate of the microphone signal and the acceleration signal is performed. Accordingly, the electronic device according to the examples of the speech enhancement scheme may require relatively large resources for using the neural network.

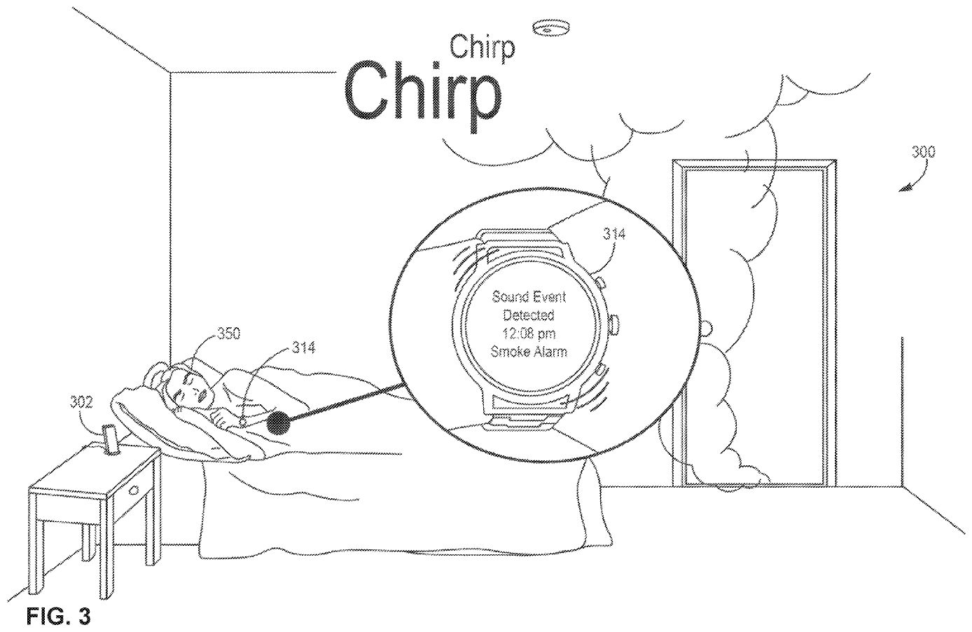

Hereinafter, an electronic device and a method according to embodiments of the present disclosure may output (or identify) the signal in which the voice portion is enhanced, by using a layer (e.g., an embedding layer) connected to the neural network using the microphone signal as an input. For example, the electronic device and the method according to embodiments of the present disclosure may enhance a voice quality of the user by using not only a voice signal obtained via the microphone but also a voice signal obtained via a sensor. For example, the embedding layer may obtain feature values by using at least one voice signal identified among the voice signal obtained via the microphone and the voice signal obtained via the sensor based on a quality of a signal (e.g., a signal to noise ratio (SNR)). The feature values may be used to output the signal in which the voice portion is enhanced. Accordingly, the electronic device and method according to embodiments of the present disclosure may perform speech enhancement by using a neural network having smaller miniaturized size. In addition, the electronic device and the method according to embodiments of the present disclosure may more clearly distinguish between a voice portion and a non-voice portion (e.g., a noise or an interference portion) of a voice signal. In addition, the electronic device and the method according to embodiments of the present disclosure may obtain a clearer voice by reducing energy loss of a specific band (e.g., a low frequency band) of the voice signal. Hereinafter, in FIG. 3, an example of functional configurations of the electronic device (e.g., the wearable device) for performing the speech enhancement scheme according to embodiments of the present disclosure is illustrated.

FIG. 3 illustrates an example of a block diagram of a wearable device. For example, in a wearable device 290 of FIG. 3, an example of a block diagram indicating functional configurations of the wearable device 290 of FIGS. 2A and 2B is illustrated.

Referring to FIG. 3, according to an embodiment, the wearable device 290 may include communication circuitry 310, a processor 320, memory 330, an outer microphone 340, an inner microphone 350, and/or a sensor 360 (e.g., accelerometer). For example, the communication circuitry 310, the processor 320, the memory 330, the outer microphone 340, the inner microphone 350, and the sensor 360 may be electronically and/or operably coupled with each other by an electronical component such as a communication bus. Hereinafter, hardware being operably coupled may mean that a direct connection or an indirect connection between the hardware is established by wire or wirelessly so that second hardware among the hardware is controlled by first hardware. Although illustrated based on different blocks, an embodiment is not limited thereto, and a portion (e.g., at least a portion of the communication circuitry 310, the processor 320, the memory 330, the outer microphone 340, the inner microphone 350, and the sensor 360) of hardware of FIG. 3 may be included in a single integrated circuit such as a system on a chip (SoC). A type and/or the number of hardware included in an electronic device 101 is not limited to as illustrated in FIG. 3. For example, the electronic device 101 may include only some of hardware components illustrated in FIG. 3.

For example, the wearable device 290 may include the communication circuitry 310 for connecting with an external electronic device. For example, the communication circuitry 310 may include the communication module 190 of FIG. 1 and the communication module of FIGS. 2A and 2B. For example, the wearable device 290 may obtain audio information from the external electronic device connected via the communication circuitry 310. For example, the wearable device 290 may output the audio information via a speaker (e.g., the sound output module 155 of FIG. 1 or the speaker 230 of FIGS. 2A and 2B).

For example, the wearable device 290 may include the processor 320. For example, the processor 320 may be configured to control the communication circuitry 310, the memory 330, the outer microphone 340, the inner microphone 350, and the sensor 360. For example, the processor 320 may perform at least one operation (or function) according to embodiments of the present disclosure below by controlling at least one configuration of the communication circuitry 310, the memory 330, the outer microphone 340, the inner microphone 350, and the sensor 360. For example, the processor 320 may perform the at least one operation (or function) by controlling the components of FIGS. 2A and 2B. For example, the processor 320 may include at least a portion of the processor 120 of FIG. 1.

For example, the processor 320 may include various processing circuitry and/or multiple processors. For example, a term “processor” used in this document, including scope of claims, may include various processing circuitry including at least one processor, and one or more of the at least one processor may be configured to perform various functions described below individually and/or collectively in a distributed manner. As used below, in case that “processor”, “at least one processor”, and “one or more processors” are described as being configured to perform various functions, these terms encompass, for example, without limitation, situations in which one processor performs a portion of cited functions and other processor(s) perform another portion of the cited functions, and also situations in which one processor may perform all of the cited functions. Additionally, the at least one processor may include a combination of processors that perform various functions listed/disclosed, for example, in a distributed manner. The at least one processor may execute program instructions to accomplish or perform various functions.

For example, the processor 320 may include hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). For example, the processor 320 may have a structure of a single-core processor, or a structure of a multi-core processor such as a dual core, a quad core, or a hexa core.

For example, the wearable device 290 may include the memory 330. For example, the memory 330 may include a hardware component for storing data and/or an instruction inputted to and/or outputted from the processor 320 of the wearable device 290. The memory 330 may include, for example, volatile memory, such as random-access memory (RAM), and/or non-volatile memory, such as read-only memory (ROM). The volatile memory may include, for example, at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disc, a solid state drive (SSD), or an embedded multi media card (eMMC).

For example, the wearable device 290 may include the outer microphone 340, the inner microphone 350, and the sensor 360. For example, the outer microphone 340 may indicate an example of the outer microphone 242 of FIGS. 2A and 2B. For example, the inner microphone 350 may indicate an example of the inner microphone 241 of FIGS. 2A and 2B. For example, the sensor 360 may indicate an example of the accelerometer 257 of FIGS. 2A and 2B. For example, the sensor 360 may include an acceleration meter (or an accelerometer). However, an embodiment of the present disclosure is not limited thereto.

According to an embodiment, the wearable device 290 may obtain a signal (e.g., a voice signal) including voice (or voice information) via each of the outer microphone 340, the inner microphone 350, and the sensor 360. For example, the wearable device 290 may obtain a first voice signal via the outer microphone 340. For example, the wearable device 290 may obtain a second voice signal via the inner microphone 350. For example, the wearable device 290 may obtain a third voice signal via the sensor 360. For example, a bandwidth of the third voice signal may be narrower than a bandwidth of the first voice signal or a bandwidth of the second voice signal. In addition, for example, a center frequency for the bandwidth of the third voice signal may be lower than a center frequency for the bandwidth of the first voice signal or a center frequency for the bandwidth of the second voice signal.

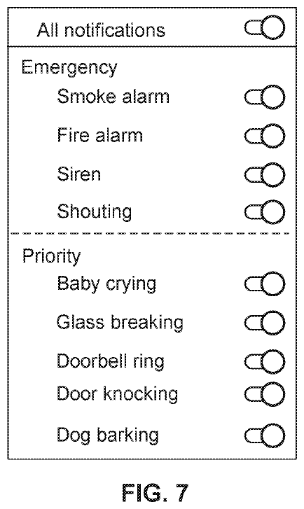

According to an embodiment, the wearable device 290 may identify at least one voice signal among the first voice signal, the second voice signal, and the third voice signal based on a quality of the first voice signal. For example, based on the quality and at least one reference level, the at least one voice signal may be identified. The wearable device 290 may obtain feature values by processing the identified at least one voice signal based on an embedding layer. The feature values may be used to perform a speech enhancement scheme. Specific content related to this is described in FIGS. 7A and 7B below.

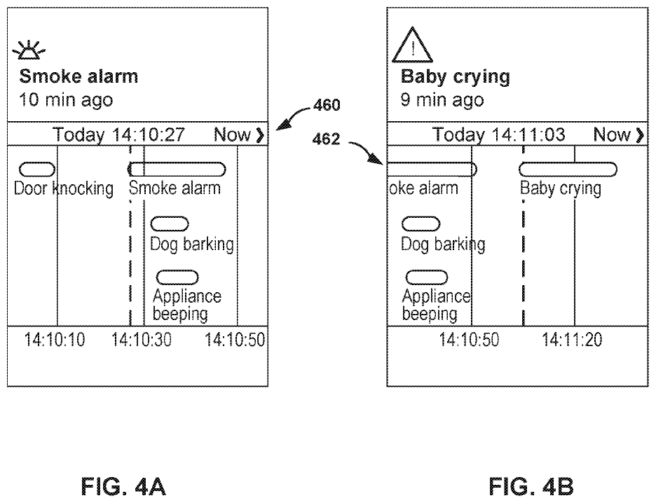

FIG. 4 illustrates an example of a neural network for processing a voice signal and an embedding layer connected to the neural network.

A neural network 400 of FIG. 4 may indicate an artificial model for performing the speech enhancement scheme. For example, by performing a processing with respect to an input signal, the neural network 400 may generate an output signal in which a voice portion of the input signal is enhanced (or a noise portion of the input signal is suppressed or cancelled). The input signal may include, for example, a voice signal.

An embedding layer 440 of FIG. 4 may indicate a layer used for the speech enhancement scheme. For example, the embedding layer 440 may generate feature values based on at least one voice signal. For example, the feature values may be inputted to some layers of the neural network 400. For example, the neural network 400 may generate the output signal based on the feature values and the input signal. The embedding layer 440 of FIG. 4 is illustrated as one layer, but an embodiment of the present disclosure is not limited thereto. For example, the embedding layer 440 may include a plurality of layers.

Referring to FIG. 4, the neural network 400 may include an encoder 410, a decoder 420, and a bottleneck layer 430. For example, the neural network 400 may include the encoder 410, the decoder 420, and the bottleneck layer 430 for performing the speech enhancement scheme.

For example, the encoder 410 may include a plurality of layers. For example, the plurality of layers included in the encoder 410 may be referred to as encoding layers. For example, the encoder 410 may perform (or execute) encoding on an input signal 413. For example, the encoder 410 may generate an output signal 415 from the input signal 413 based on the performance (or the execution) of the encoding. For example, the output signal 415 may include feature values for a voice portion of the input signal 413. The input signal 413 may indicate an input signal of the neural network 400. Hereinafter, the feature values for a voice portion of the output signal 415 may be referred to as first feature values. For example, the first feature values may be used as an input signal of the bottleneck layer 430.

For example, the decoder 420 may include a plurality of layers. For example, the plurality of layers included in the decoder 420 may be referred to as decoding layers. For example, the decoder 420 may perform (or execute) decoding on an input signal 423. For example, the decoder 420 may generate an output signal 425 from the input signal 423 based on the performance (or the execution) of the decoding. For example, the output signal 425 may include a signal in which the voice portion of the voice signal 413 is enhanced (or a noise portion of the voice signal 413 is suppressed or cancelled). For example, the output signal 425 may indicate the output signal of the neural network 400.

For example, the bottleneck layer 430 may indicate a layer having the smallest size among layers included in the neural network 400. For example, the size of the layer may indicate the number of nodes or weights included in the layer. For example, the bottleneck layer 430 may be connected to an output layer among the encoding layers of the encoder 410. For example, the bottleneck layer 430 may be connected to an input layer among the decoding layers of the decoder 420. For example, the output layer may indicate a layer generating output data by being positioned last among one or more layers. For example, the input layer may indicate a layer to which input data is inputted by being positioned first among one or more layers.

According to an embodiment, the bottleneck layer 430 may be connected to the embedding layer 440. For example, the bottleneck layer 430 may obtain an output signal 445 of the embedding layer 440. For example, the output signal 445 may include feature values of at least one input signal 443. Hereinafter, the feature values obtained from the embedding layer 440 may be referred to as second feature values. For example, the bottleneck layer 430 may obtain the first feature values from the encoding layers of the encoder 410 and the second feature values from the embedding layer 440. For example, the bottleneck layer 430 may generate the input signal 423 of the decoder 420 based on the first feature values and the second feature values. For example, the bottleneck layer 430 may connect the second feature values (or the first feature values) with respect to the first feature values (or the second feature values) through concatenation. In addition, for example, the bottleneck layer 430 may synthesize the first feature values and the second feature values into one feature value. For example, the first feature values may indicate a feature value extracted with respect to the voice portion of the input signal 413. The second feature values may indicate a feature value extracted with respect to a voice portion of the input signal 443.

In the above-described examples, a first layer being connected to a second layer after the first layer may indicate that size of data outputted from the first layer corresponds to size of the second layer (or size of inputtable data). For example, in a case that the size of the data outputted from the first layer is first size and the size of the second layer is the first size, the first layer and the second layer may be connected. In contrast, the first layer may not be connected to the second layer in a case that the size of the data outputted from the first layer is the first size and the size of the second layer is second size different from the first size, or may be inputted to the second layer after an additional processing of the data having the first size is performed. The first layer and the second layer are merely for convenience of description and should not be interpreted as being limited to a specific layer.

For example, the embedding layer 440 may generate the second feature values based on the input signal 443. For example, the input signal 443 may include at least one voice signal. For example, the at least one voice signal may include at least one of a first voice signal, a second voice signal, and a third voice signal. For example, the first voice signal may be obtained via an outer microphone (e.g., the outer microphone 340 of FIG. 3) of a wearable device 290. For example, the input signal 413 of the neural network 400 may include the first voice signal. For example, the second voice signal may be obtained via an inner microphone (e.g., the inner microphone 350 of FIG. 3) of the wearable device 290. For example, the third voice signal may be obtained via a sensor (e.g., the sensor 360 of FIG. 3) of the wearable device 290. For example, the third voice signal may include information on vibration of a body portion obtained in a state in which the wearable device 290 is worn at the body portion of a user. For example, a bandwidth of the third voice signal may be lower than a bandwidth of the first voice signal and a bandwidth of the second voice signal. For example, size of the bandwidth of the third voice signal may be approximately 4 kHz. For example, each size of the bandwidth of the first voice signal and the bandwidth of the second voice signal may be approximately 16 kHz. However, the above-described examples are merely for convenience of description, and an embodiment of the present disclosure is not limited thereto. The input signal 443 may include the at least one voice signal identified from among the first voice signal, the second voice signal, and the third voice signal based on a quality of the first voice signal. For example, the quality of the first voice signal may include a signal to noise ratio (SNR). However, an embodiment of the present disclosure is not limited thereto. For example, the quality of the first voice signal may include a signal to interference-plus-noise ratio (SINR), a carrier to noise ratio (CNR), or a modulation to error ratio (MER). For example, the input signal 443 may be identified based on a noise environment (or an external environment) for the wearable device 290 (or the user wearing the wearable device 290).

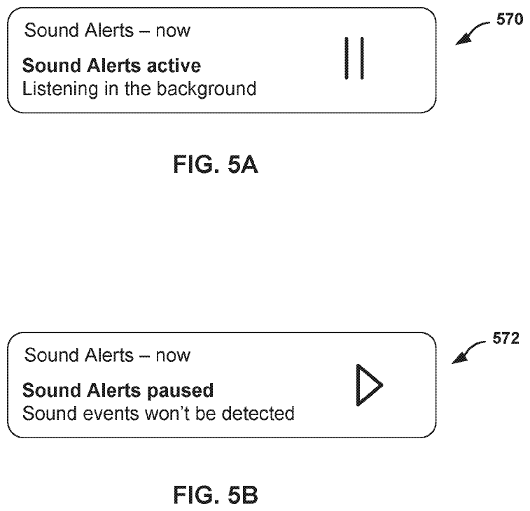

According to an embodiment, a preprocessing (or a processing) to the input signal 443 may be performed with respect to the at least one voice signal identified based on the quality. For example, the preprocessing for the at least one voice signal may include at least one from among a filtering, a Fourier transform, a cancellation of a component in a specific frequency band, or a feature extraction scheme. For example, based on the preprocessing, a 2 dimensional (2D) vector may be generated from the input signal 443. The 2 dimensional vector may indicate a feature vector for time and frequency. The feature vector may be referred to as an embedding vector. For example, based on the embedding layer 440, the second feature values may be generated from the feature vector. Specific content related to this is described in FIGS. 5 and 7B below.

According to an embodiment, the neural network 400 may be trained based on a difference between an output signal obtained based on an input signal (or a noisy signal) including a speech signal and a noise signal obtained from the outer microphone and the inner microphone, and the speech signal. For example, the speech signal may include a specific speech obtained by the wearable device 290 in an anechoic chamber. The noisy signal may include the specific speech obtained by the wearable device 290 in an environment (e.g., the external environment or the noise environment) other than the anechoic chamber. For example, the noise signal may include a portion of the noisy signal excluding the speech signal. In addition, the embedding layer 440 may be trained based on the difference. For example, the neural network 400 may obtain the first feature values based on the noisy signal including the speech signal and the noise signal. For example, the neural network 400 may obtain the second feature values from the embedding layer 440. The second feature values may be obtained based on the embedding layer 440 from the at least one voice signal identified from among the first voice signal, the second voice signal, and the third voice signal. For example, the neural network 400 may obtain the output signal based on the first feature values and the second feature values based on the noisy signal. For example, the neural network 400 may identify the difference between the output signal and the speech signal. For example, the neural network 400 may be learned based on the difference. In addition, the embedding layer 440 may also be trained based on the difference. For example, the embedding layer 440 may be trained for substantially the same purpose (e.g., the speech enhancement scheme) as the neural network 400. The training for the neural network 400 and the embedding layer 440 may include, for example, an operation of generating, designing, and training the neural network 400 and the embedding layer 440. For example, the training may include an operation of adjusting a weight of a layer included in the neural network 400 and the embedding layer 440.

Referring to FIG. 4, in an embodiment, the neural network 400 may be formed in a U-net structure. For example, the U-net structure may indicate a structure in which size of a layer is reduced from an input layer of the encoding layers of the encoder 410 to the bottleneck layer 430 and the size of the layer is expanded again from the bottleneck layer 430 to an output layer of the decoding layers of the decoder 420. However, an embodiment of the present disclosure is not limited thereto. For example, the neural network 400 may include a plurality of layers, and each of the plurality of layers may have the same size. Alternatively, size of the plurality of layers included in the neural network 400 may be repeatedly expanded or reduced. Alternatively, the size of each of the plurality of layers included in the neural network 400 may be defined as any size. In the above-described examples, a specific layer among the plurality of layers may perform the same operation (or function) as the bottleneck layer 430. In addition, within the above-described examples, the embedding layer 440 may be connected to at least one layer of the neural network 400. At this time, size of the embedding layer 440 (or the output layer of the embedding layer 440) may correspond to size of a layer connected to the neural network 400.

In FIG. 4, an example in which the neural network 400 and the embedding layer 440 are separate configurations is illustrated, but an embodiment of the present disclosure is not limited thereto. For example, the neural network 400 and the embedding layer 440 may be referred to as one neural network.

FIG. 5 illustrates an example of a method of training an embedding layer and a neural network and inferring based on the embedding layer and the neural network.

For example, the method may be performed by the wearable device 290 of FIG. 3 (or the electronic device 101 of FIG. 1, or the wearable device 290 of FIG. 2A and FIG. 2B). For example, at least one operation of the method may be controlled by a processor 320. An embedding layer 440 of FIG. 5 may indicate an example of the embedding layer 440 of FIG. 4. A neural network 400 of FIG. 5 may indicate an example of the neural network 400 of FIG. 4.

For example, the training may indicate an operation of generating, designing, and training the neural network 400 and the embedding layer 440. For example, the inference may indicate an operation of obtaining an output signal in which a voice portion is enhanced (or a noise is suppressed) using voice signals based on the neural network 400 and the embedding layer 440.

Referring to FIG. 5, in an embodiment, the wearable device 290 may include a voice signal obtaining unit 510, a voice signal identification unit 520, a feature extraction unit 530, the embedding layer 440, and the neural network 400. For example, the voice signal obtaining unit 510, the voice signal identification unit 520, and the feature extraction unit 530 may be formed by hardware, software, or a combination of hardware and software. For example, the voice signal obtaining unit 510, the voice signal identification unit 520, the feature extraction unit 530, the embedding layer 440, and the neural network 400 may be controlled based on one or more instructions for executing a specific operation (or function).

According to an embodiment, the wearable device 290 may obtain a signal including voice (a voice signal) from the outside by using the voice signal obtaining unit 510. For example, the voice signal obtaining unit 510 may include an outer microphone (e.g., the outer microphone 340 of FIG. 3), an inner microphone (e.g., the inner microphone 350 of FIG. 3), or a sensor (e.g., the sensor 360 of FIG. 3). In the above-described example, the wearable device 290 may obtain a first voice signal using the outer microphone. For example, the wearable device 290 may obtain a second voice signal using the inner microphone. For example, the wearable device 290 may obtain a third voice signal using the sensor.

According to an embodiment, the wearable device 290 may provide the neural network 400 with the first voice signal as an input signal 515. For example, the neural network 400 may use the first voice signal as the input signal 515. For example, the first voice signal may be a noisy signal. The noisy signal may include, for example, a speech signal and a noise signal.

According to an embodiment, the wearable device 290 may identify at least one voice signal using the voice signal identification unit 520. For example, the wearable device 290 may identify a quality of the first voice signal. For example, the quality may include an SNR, an SINR, a CNR, or an MER of the first voice signal. According to an embodiment, the wearable device 290 may compare the identified quality with reference levels. For example, the wearable device 290 may identify whether the quality is greater than or equal to a first reference level among the reference levels. In addition, the wearable device 290 may identify whether the quality is greater than or equal to a second reference level among the reference levels. For example, in a case that the quality is less than the first reference level, the wearable device 290 may identify the third voice signal as the at least one voice signal. For example, in a case that the quality is greater than or equal to the first reference level and less than the second reference level, the wearable device 290 may identify the second voice signal and the third voice signal as the at least one voice signal. For example, in a case that the quality is greater than or equal to the second reference level, the wearable device 290 may identify the first voice signal as the at least one voice signal. Specific content related to this is described in FIG. 7A below.

According to an embodiment, the wearable device 290 may extract a feature for the identified at least one voice signal by using the feature extraction unit 530. For example, the wearable device 290 may perform a preprocessing to extract the feature for the at least one voice signal. For example, the preprocessing may include at least one from among a filtering, a Fourier transform, a cancellation of a component in a specific frequency band, or a feature extraction (or a feature extraction algorithm or a feature extraction scheme), for the identified at least one voice signal.

For example, the filtering may include a band pass filter (BPF) for a voice portion of the at least one voice signal. For example, based on the BPF, the wearable device 290 may obtain a signal of a band in which the voice portion is positioned, from among bandwidths for the at least one voice signal. For example, the Fourier transform may include a short-time Fourier transform. The wearable device 290 may perform the Fourier transform on the filtered at least one voice signal. For example, the cancellation of the component in the specific frequency band may indicate a process of cancelling a direct component in a low frequency band (e.g., approximately 0 kHz) of the at least one voice signal. The direct component may indicate an element of a signal generated according to a calculation for the Fourier transform. For example, the direct component may be referred to as a Fourier element. For example, the wearable device 290 may perform the cancellation for the Fourier transformed at least one voice signal. For example, the feature extraction may indicate a process of extracting an audio feature of the at least one voice signal. For example, the feature extraction may include a mel-filter cepstral coefficient (MFCC) algorithm using a mel-filter bank. However, an embodiment of the present disclosure is not limited thereto. For example, an electronic device and a method according to an embodiment of the present disclosure may be applied to a feature extraction algorithm capable of extracting the audio feature. For example, the wearable device 290 may perform the feature extraction with respect to the cancelled at least one voice signal. For example, the wearable device 290 may obtain a feature vector based on the feature extraction. For example, the feature vector may indicate a vector from which a feature is extracted with respect to the at least one voice signal according to time and frequency. For example, the feature vector may indicate a 2 dimensional vector.

According to an embodiment, the wearable device 290 may obtain second feature values based on the embedding layer 440. For example, the wearable device 290 may obtain the second feature values from the feature vector based on the embedding layer 440. For example, the feature vector may be an input signal of the embedding layer 440. For example, the second feature values may be an output signal of the embedding layer 440.

Although not illustrated in FIG. 5, the wearable device 290 may generate the input signal 515 by applying the Fourier transform (e.g., the short-time Fourier transform) to the first voice signal. For example, the input signal 515 may indicate the Fourier transformed first voice signal.

According to an embodiment, the wearable device 290 may provide the input signal 515 and the second feature values to the neural network 400. For example, the wearable device 290 may input the input signal 515 into an input layer (e.g., the input layer among the encoding layers of the encoder 410 of FIG. 4) of the neural network 400. In addition, for example, the wearable device 290 may input the second feature values to at least one layer (e.g., the bottleneck layer 430 of FIG. 4) of the neural network 400. For example, the wearable device 290 may obtain first feature values based on at least a portion (e.g., the encoding layers of the encoder 410 of FIG. 4) of the neural network 400. For example, the wearable device 290 may obtain the output signal in which the voice portion is enhanced (or a noise portion is suppressed), based on the first feature values and the second feature values. For example, the first feature values may indicate a feature value extracted with respect to a voice portion of the first voice signal. The second feature values may indicate a feature value extracted with respect to a voice portion of the at least one voice signal.

According to an embodiment, the wearable device 290 may train the neural network 400 and the embedding layer 440 using the voice signal obtaining unit 510, the voice signal identification unit 520, and the feature extraction unit 530 exemplified in FIG. 5. For example, in relation to the training, a speech signal and a noisy signal may be used. For example, the speech signal used in the training may indicate a signal including a specific speech (or specified voice) obtained by the wearable device 290 in an anechoic chamber. For example, the specific speech (or the specified voice) may indicate information on voice, which is preset or stored in the wearable device 290, used to train the neural network 400 and the embedding layer 440. For example, the noisy signal used in the training may include the speech signal for the specific speech obtained by the wearable device 290 in an environment other than the anechoic chamber. The first voice signal used in the training may include the noisy signal obtained via the outer microphone. For example, the wearable device 290 may obtain the first voice signal, the second voice signal obtained via the inner microphone for the specific speech, and the third voice signal obtained via the sensor for the specific speech, by using the voice signal obtaining unit 510. For example, the wearable device 290 may identify at least one voice signal from among the first voice signal, the second voice signal, and the third voice signal for the specific speech, by using the voice signal identification unit 520. For example, the wearable device 290 may extract the second feature values of the at least one voice signal for the specific speech by using the feature extraction unit 530. For example, based on the neural network 400, the wearable device 290 may obtain an output signal in which the specific speech portion is enhanced, by using the first voice signal and the second feature values for the specific speech. According to an embodiment, the wearable device 290 may compare the output signal with the speech signal obtained (or pre-stored) in the anechoic chamber. For example, the wearable device 290 may identify a difference between the output signal and the speech signal. According to an embodiment, the wearable device 290 may train the neural network 400 and the embedding layer 440 based on the difference. For example, the difference may indicate similarity or an error of the noisy signal for the speech signal.

According to an embodiment, the wearable device 290 may infer (or obtain the signal in which the voice portion is enhanced) using the voice signal obtaining unit 510, the voice signal identification unit 520, the feature extraction unit 530, the neural network 400, and the embedding layer 440 exemplified in FIG. 5. Unlike the training process, in an inference process, the first voice signal may include the noisy signal for the specific speech and arbitrary voice uttered by a user of the wearable device 290 other than the speech signal. For example, the first voice signal may indicate a signal including the arbitrary voice obtained via the outer microphone. For example, the wearable device 290 may obtain the first voice signal, the second voice signal obtained via the inner microphone for the arbitrary voice, and the third voice signal obtained via the sensor for the arbitrary voice, by using the voice signal obtaining unit 510. For example, the wearable device 290 may identify at least one voice signal from among the first voice signal, the second voice signal, and the third voice signal for the arbitrary voice, by using the voice signal identification unit 520. For example, the wearable device 290 may extract the second feature values of the at least one voice signal for the arbitrary voice by using the feature extraction unit 530. For example, based on the neural network 400, the wearable device 290 may obtain an output signal in which the arbitrary voice portion is enhanced, by using the first voice signal and the second feature values for the arbitrary voice.

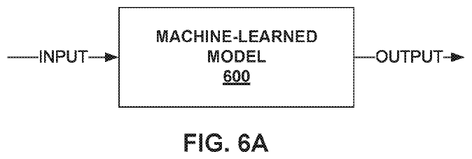

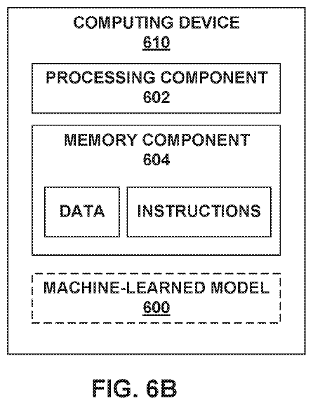

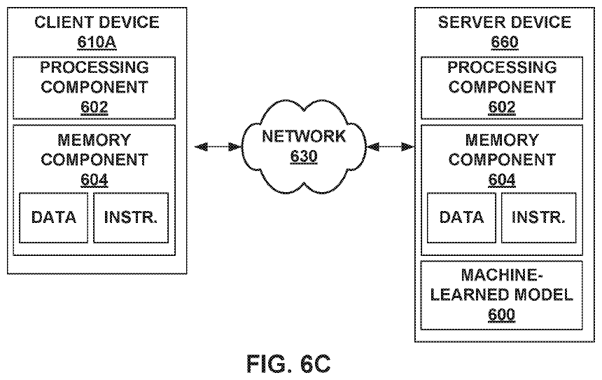

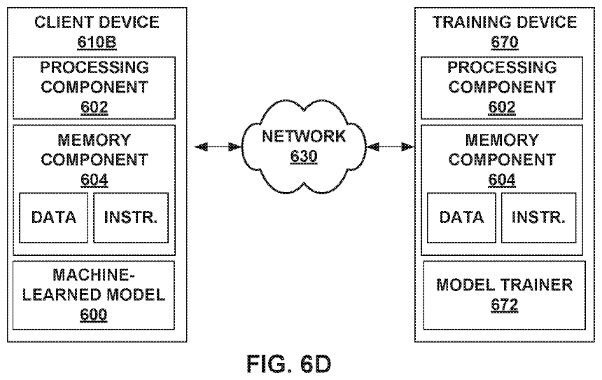

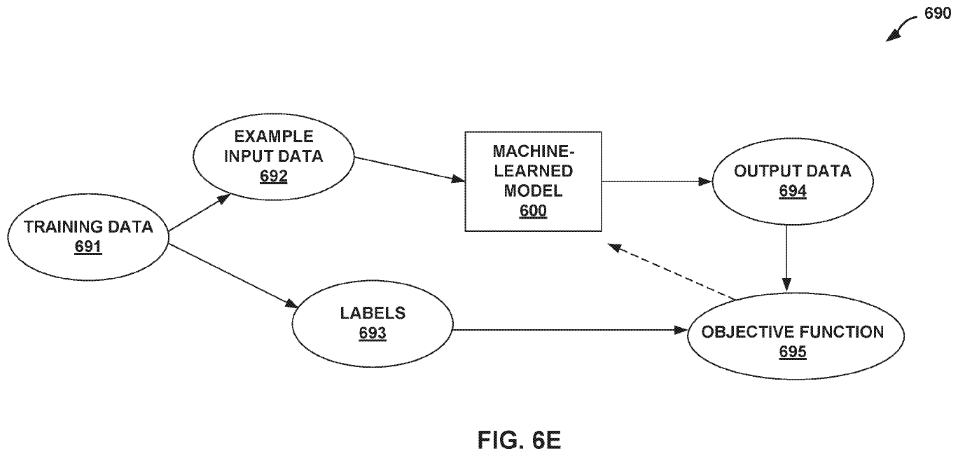

FIG. 6 illustrates an example of an operation flow for a method of obtaining a signal in which a noise is suppressed via a trained embedding layer and neural network.

The method of FIG. 6 may be performed by the wearable device 290 of FIG. 3 (or the wearable device 290 of FIG. 5, the wearable device 290 of FIGS. 2A and 2B, or the electronic device 101 of FIG. 1). For example, at least one operation of the method may be controlled by a processor 320.

Referring to FIG. 6, in an embodiment, the wearable device 290 may identify a neural network and an embedding layer. For example, the wearable device 290 may identify the neural network and the embedding layer for a speech enhancement scheme for obtaining the signal in which the noise is suppressed. For example, the neural network may include the neural network 400 of FIGS. 4 and 5. For example, the embedding layer may include the embedding layer 440 of FIGS. 4 and 5. For example, the identified neural network may be a neural network trained based on a speech signal and a noisy signal for a specific speech (or specified voice). In addition, for example, the identified embedding layer may be an embedding layer trained based on the speech signal and the noisy signal for the specific speech. For example, the identified neural network and the identified embedding layer may obtain an output signal in which a voice portion is enhanced (or a noise portion is suppressed) via a processing with respect to the noisy signal. The identified neural network and the identified embedding layer may be in a trained state based on a difference between the output signal and the speech signal. For example, the identified neural network and the identified embedding layer may be in a trained state, as described in FIG. 5.

In FIG. 6, the wearable device 290 is illustrated as identifying the neural network and the embedding layer, but an embodiment of the present disclosure is not limited thereto. For example, the wearable device 290 may perform operation 620 to operation 650 via the neural network and the embedding layer included in the wearable device 290 without the identifying operation. For example, operation 610 may be omitted.

In the operation 620, the wearable device 290 may obtain a plurality of voice signals based on a plurality of microphones and a sensor. For example, the wearable device 290 may obtain a first voice signal via an outer microphone (e.g., the outer microphone 340 of FIG. 3).

For example, the wearable device 290 may obtain a second voice signal via an inner microphone (e.g., the inner microphone 350 of FIG. 3). For example, the wearable device 290 may obtain a third voice signal via the sensor (e.g., the sensor 360 of FIG. 3). The plurality of voice signals may include the first voice signal, the second voice signal, and the third voice signal. The plurality of microphones may include the outer microphone and the inner microphone. For example, the sensor may include an acceleration meter (or an accelerometer).

In operation 630, the wearable device 290 may identify at least one voice signal based on a quality of a signal. For example, the wearable device 290 may identify the at least one voice signal from the plurality of voice signals based on a quality of the first voice signal. For example, the quality may include an SNR, an SINR, a CNR, or an MER of the first voice signal. Identifying the at least one voice signal is described in detail in FIG. 7A below.

In operation 640, the wearable device 290 may obtain feature values from the at least one voice signal based on the embedding layer. For example, the wearable device 290 may obtain the feature values by performing a preprocessing (or a processing) to extract a feature for the at least one voice signal. For example, the preprocessing may include at least one from among a filtering, a Fourier transform, a cancellation of a component in a specific frequency band, or a feature extraction (e.g., a feature extraction algorithm or a feature extraction scheme), for the identified at least one voice signal. The feature values obtained based on the embedding layer may be referred to as second feature values. For example, the wearable device 290 may obtain the second feature values from the preprocessed at least one voice signal (or a feature vector) based on the embedding layer.

In the operation 650, the wearable device 290 may obtain the signal in which the noise is suppressed (or cancelled) from the voice signal obtained via the outer microphone, based on the neural network and the embedding layer. For example, the wearable device 290 may generate the signal in which the noise is suppressed from the first voice signal, based on the neural network and the embedding layer.

For example, the wearable device 290 may provide the neural network with the first voice signal as an input signal. For example, the wearable device 290 may obtain first feature values from the first voice signal based on at least a portion of the neural network. For example, the wearable device 290 may provide the second feature values to a specific layer (e.g., a bottleneck layer) of the neural network connected to the embedding layer. The wearable device 290 may generate the signal in which the noise is suppressed, based on the first feature values and the second feature values. For example, the first feature values may indicate a feature value extracted with respect to a voice portion of the first voice signal. For example, the second feature values may indicate a feature value extracted with respect to a voice portion of the at least one voice signal.

FIG. 7A illustrates an example of an operation flow for a method of identifying at least one voice signal for an embedding layer from a plurality of voice signals.

The method of FIG. 7A may be performed by the wearable device 290 of FIG. 3 (or the wearable device 290 of FIG. 5, the wearable device 290 of FIGS. 2A and 2B, or the electronic device 101 of FIG. 1). For example, at least one operation of the method may be controlled by a processor 320.

In operation 710, the wearable device 290 may obtain a plurality of voice signals. For example, the wearable device 290 may obtain a plurality of voice signals via a plurality of microphones and a sensor. For example, each of the plurality of voice signals may indicate a signal including voice uttered by a user of the wearable device 290. For example, the plurality of voice signals may include a first voice signal, a second voice signal, and a third voice signal. For example, the wearable device 290 may obtain the first voice signal using an outer microphone (e.g., the outer microphone 340 of FIG. 3). For example, the wearable device 290 may obtain the second voice signal using an inner microphone (e.g., the inner microphone 350 of FIG. 3). For example, the wearable device 290 may obtain the third voice signal using the sensor (e.g., the sensor 360 of FIG. 3). The outer microphone and the inner microphone may be included, for example, in the plurality of microphones.

According to an embodiment, the wearable device 290 may identify a quality of the first voice signal. For example, the wearable device 290 may identify a ratio of the voice of the first voice signal obtained from the outer microphone to a noise of the first voice signal. For example, the wearable device 290 may identify an SNR, which is the quality of the first voice signal. However, an embodiment of the present disclosure is not limited thereto. For example, the quality may include an SINR, a CNR, or an MER of the first voice signal.

In operation 715, the wearable device 290 may identify whether the quality of the first voice signal is greater than or equal to a first reference level. For example, the wearable device 290 may identify whether the quality is greater than or equal to the first reference level. For example, the first reference level may indicate a threshold value for the quality. For example, the first reference level may be identified based on at least one of information on an external environment (or a noise environment) for the wearable device 290 or information on the user of the wearable device 290. For example, the external environment may include an area in a specified distance from the wearable device 290. For example, the information on the external environment may include whether the external environment is currently daytime or evening, or a noise level. For example, the first reference level may be formed higher when the external environment is daytime than when the external environment is night. In addition, the information on the user may include an age (years) of the user or an average volume of voice of the user. For example, the first reference level may be formed higher when the user is older than when the user is younger. For example, the first reference level may be formed higher for a user with the average volume that is higher than a user with the average volume that is relatively low. However, an embodiment of the present disclosure is not limited thereto. For example, the first reference level and a second reference level below may be set to fixed specific values.

In a case that the quality of the first voice signal is identified to be greater than or equal to the first reference level in the operation 715, the wearable device 290 may perform operation 725. In a case that the quality of the first voice signal is identified to be less than the first reference level in the operation 715, the wearable device 290 may perform operation 720.

In the operation 720, the wearable device 290 may identify the third voice signal. For example, the wearable device 290 may identify the third voice signal as at least one voice signal for an input signal for the embedding layer. For example, in a case that the quality of the first voice signal is less than the first reference level, the wearable device 290 may identify the third voice signal as the at least one voice signal. The quality of the first voice signal being less than the first reference level may indicate a state in which reliability of the first voice signal obtained via the outer microphone is low due to a large amount of noise (and/or interference) in the external environment of the wearable device 290. Therefore, the wearable device 290 may identify the third voice signal including information on vibration indicating the voice as the at least one voice signal.

In the operation 725, the wearable device 290 may identify whether the quality of the first voice signal is greater than or equal to the second reference level. For example, the wearable device 290 may identify whether the quality of the first voice signal is greater than or equal to the second reference level based on identifying that the quality of the first voice signal is greater than or equal to the first reference level. For example, the second reference level may indicate the threshold value for the quality. For example, the second reference level may be identified based on at least one of the information on the external environment (or the noise environment) of the wearable device 290, or the information on the user of the wearable device 290, similar to the first reference level. For example, the first reference level and the second reference level may be set to the fixed specific values. For example, the second reference level may indicate a level having a quality higher than that of the first reference level.

In a case that the quality of the first voice signal is greater than or equal to the second reference level (and greater than or equal to the first reference level) in the operation 725, the wearable device 290 may perform operation 735. In a case that the quality of the first voice signal is less than the second reference level (and greater than or equal to the first reference level) in the operation 725, the wearable device 290 may perform operation 730.

In the operation 730, the wearable device 290 may identify the second voice signal and the third voice signal. For example, the wearable device 290 may identify the second voice signal and the third voice signal as the at least one voice signal for the input signal for the embedding layer. For example, in a case that the quality of the first voice signal is greater than or equal to the first reference level and less than the second reference level, the wearable device 290 may identify the second voice signal and the third voice signal as the at least one voice signal. The quality of the first voice signal being greater than or equal to the first reference level and less than the second reference level may indicate a state in which the reliability of the first voice signal obtained via the outer microphone is medium due to presence of some noise (and/or interference) in the external environment of the wearable device 290. Therefore, the wearable device 290 may identify, via the inner microphone, the second voice signal including information on the voice and the third voice signal including information on the vibration indicating the voice as the at least one voice signal.

In the operation 735, the wearable device 290 may identify the first voice signal. For example, the wearable device 290 may identify the first voice signal as the at least one voice signal for the input signal for the embedding layer. For example, in a case that the quality of the first voice signal is greater than or equal to the second reference level, the wearable device 290 may identify the first voice signal as the at least one voice signal. The quality of the first voice signal being greater than or equal to the second reference level may indicate a state in which reliability of the first voice signal obtained via the outer microphone is high due to little or no noise (and/or interference) in the external environment of the wearable device 290. Therefore, the wearable device 290 may identify, via the outer microphone, the first voice signal including information on the voice as the at least one voice signal.

When referring to the above description, it is exemplified that the wearable device 290 compares the second reference level after comparing the quality of the identified first voice signal with the first reference level, but an embodiment of the present disclosure is not limited thereto. For example, the wearable device 290 may compare the first reference level after comparing the quality of the first voice signal with the second reference level. For example, the wearable device 290 may compare the quality of the first voice signal with the first reference level and the second reference level at once.

FIG. 7B illustrates an example of an operation flow for a method of obtaining a feature value via an embedding layer. The embedding layer of FIG. 7B may indicate an example of the embedding layer 440 of FIG. 4.

The method of FIG. 7B may be performed by the wearable device 290 of FIG. 3 (or the wearable device 290 of FIG. 5, the wearable device 290 of FIGS. 2A and 2B, or the electronic device 101 of FIG. 1). For example, at least one operation of the method may be controlled by a processor 320.

Referring to FIG. 7B, in operation 750, the wearable device 290 may identify at least one voice signal. For example, the wearable device 290 may identify the at least one voice signal from among a plurality of voice signals based on a quality of a signal. The at least one voice signal may be identified from the plurality of voice signals based on the method of FIG. 7A. The description of FIG. 7A may be substantially identically applied to identifying the at least one voice signal.

In operation 760, the wearable device 290 may perform a filtering. For example, wearable device 290 may perform the filtering on the at least one voice signal. For example, the filtering may include a band pass filter (BPF) for a voice portion of the at least one voice signal. For example, based on the BPF, the wearable device 290 may obtain a signal in a band in which the voice portion is positioned among bandwidths for the at least one voice signal. The band in which the voice portion is positioned may indicate, for example, a voice band (a band of approximately 4 kHz or less). The voice band may include, for example, an audible frequency band.

In operation 770, the wearable device 290 may perform a Fourier transform. For example, the wearable device 290 may perform the Fourier transform on the filtered at least one voice signal. For example, the Fourier transform may include a short-time Fourier transform.

In operation 780, the wearable device 290 may perform a cancellation of a component in a specific frequency band. For example, the wearable device 290 may perform the cancellation on the Fourier transformed at least one voice signal. For example, the cancellation of the component in the specific frequency band may indicate a process of cancelling a direct component in a low frequency band (e.g., approximately 0 kHz) of the at least one voice signal. For example, the direct component may indicate an element of a signal generated according to a calculation for the Fourier transform.

According to an embodiment, as at least some of the above-described operations are performed, bandwidths of a first voice signal obtained via an outer microphone (e.g., the outer microphone 340 of FIG. 3), a second voice signal obtained via an inner microphone (e.g., the inner microphone 350 of FIG. 3), and a third voice signal obtained via a sensor (e.g., the sensor 360 of FIG. 3) may be adjusted to correspond to each other. The adjusted first voice signal (or the adjusted second voice signal) may have the bandwidth similar to the third voice signal. For example, the adjusted first voice signal to be used as an input of an embedding layer 440 may have a different bandwidth from the first voice signal to be used as an input of a neural network 400.

In operation 790, the wearable device 290 may perform a feature extraction. For example, the wearable device 290 may perform the feature extraction on the cancelled at least one voice signal. For example, the feature extraction may indicate a process of extracting an audio feature of the at least one voice signal. For example, the feature extraction may include a mel-filter cepstral coefficient (MFCC) algorithm using a mel-filter bank. However, an embodiment of the present disclosure is not limited thereto. For example, an electronic device and a method according to an embodiment of the present disclosure may be applied to a feature extraction algorithm capable of extracting the audio feature. For example, the wearable device 290 may obtain a feature vector based on the feature extraction. For example, the feature vector may indicate a vector from which a feature is extracted with respect to the at least one voice signal according to time and frequency. For example, the feature vector may indicate a 2 dimensional vector.

According to an embodiment, the wearable device 290 may obtain second feature values based on the embedding layer. For example, the wearable device 290 may obtain the second feature values from the feature vector based on the embedding layer. For example, the feature vector may be an input signal (e.g., the input signal 443 of FIG. 4) of the embedding layer. For example, the second feature values may be an output signal (e.g., the output signal 445 of FIG. 4) of the embedding layer.

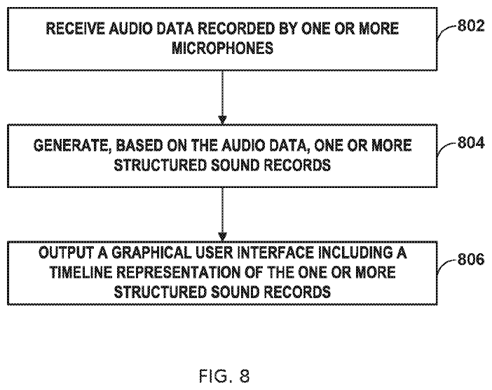

FIGS. 8A and 8B illustrate examples of a signal processed via an embedding layer and a neural network.

For example, the neural network may include the neural network 400 of FIGS. 4 and 5. For example, the embedding layer may include the embedding layer 440 of FIGS. 4 and 5.

FIGS. 8A and 8B illustrate examples of a spectrogram of a first signal in which a voice portion is enhanced via the neural network and a second signal in which a voice portion is enhanced via the neural network including the embedding layer according to embodiments of the present disclosure. For example, in a graph 800, a graph 820, a graph 840, and a graph 860 of FIGS. 8A and 8B, a horizontal axis may indicate time and a vertical axis may indicate frequency. The vertical axis may indicate a higher frequency as it extends upward.

Referring to FIG. 8A, the graph 800 illustrating an example of a spectrogram for the first signal and the graph 820 illustrating an example of a spectrogram for the second signal are illustrated. Referring to the graph 800 and the graph 820, a voice portion 830 of specified time and specified low frequency band of the second signal may be more clearly displayed than a voice portion 810 of the specified time and the specified low frequency band of the first signal. For example, the second signal processed via the neural network using the embedding layer may include clearer voice than the first signal processed using only the neural network. For example, an electronic device and a method according to embodiments of the present disclosure may obtain (or identify) a clearer voice signal in a low frequency band by using the neural network including the embedding layer.

Referring to FIG. 8B, the graph 840 illustrating an example of a spectrogram for the first signal and the graph 860 illustrating an example of a spectrogram for the second signal are illustrated. Referring to the graph 840 and the graph 860, a time period 870 not including the voice portion of the second signal may include less noise than a time period 850 not including the voice portion of the first signal. For example, the second signal processed via the neural network using the embedding layer may be in a state in which a voice portion and a non-voice portion (or a noise portion) are more accurately distinguished than the first signal processed using only the neural network. In the electronic device and the method according to embodiments of the present disclosure, noise cancellation performance may be enhanced by more accurately distinguishing the voice portion and the non-voice portion via the neural network using the embedding layer. Referring to the above description, the embedding layer (or second feature values (or a feature vector) generated from the embedding layer) may be used as a voice activity detector for detecting the voice portion.

In addition, although not illustrated in FIG. 8B, the electronic device and the method according to embodiments of the present disclosure may more precisely identify a level of the voice portion according to a frequency band by using the neural network including the embedding layer. For example, the neural network that does not use the embedding layer may identify the first signal as 1 (voice) when a level of the first signal according to the frequency band is greater than or equal to a certain value, and only identify the first signal as 0 (non-voice) when the level of the first signal is less than the certain value. In contrast, in the electronic device and the method according to embodiments of the present disclosure, the neural network using the embedding layer may identify the second signal as 1 (voice) when a level of the second signal is greater than or equal to the certain value, and may also identify specific values indicating the level of the voice portion.

Referring to the above description, the electronic device and the method according to embodiments of the present disclosure may output a signal in which a voice portion is enhanced by using a layer connected to the neural network (e.g., the embedding layer). For example, the electronic device and the method according to embodiments of the present disclosure may improve a voice quality of the user by using not only a voice signal obtained via a microphone (e.g., the first voice signal and the second voice signal) but also a voice signal obtained via a sensor (e.g., the third voice signal). For example, the embedding layer may obtain feature values by using at least one voice signal identified among the voice signal obtained via the microphone and the voice signal obtained via the sensor based on a quality of a signal (e.g., a signal to noise ratio (SNR)). The feature values may be used to output the signal in which the voice portion is enhanced. At this time, the first voice signal and the second voice signal used as an input of the embedding layer may have a frequency band (or a sampling rate) different from the third voice signal. As the electronic device and the method according to embodiments of the present disclosure are processed to have substantially the same frequency band in a preprocessing process for the input of the embedding layer, there is no need to consider a limitation of a plurality of input modules (e.g., the plurality of microphones and the sensor). For example, in the electronic device and the method according to embodiments of the present disclosure, a process of compensating for a separate frequency band may be omitted even when using various types of sensors and microphones, and as small-sized data (e.g., reducing a bandwidth of the first voice signal and the second voice signal to correspond to a bandwidth of the third voice signal) is used as an input, an amount of calculation is low, so fewer resources may be used. Accordingly, the electronic device and the method according to embodiments of the present disclosure may perform speech enhancement by using a neural network having a smaller miniaturized size. The electronic device and the method according to embodiments of the present disclosure may more clearly distinguish between a voice portion and a non-voice portion (e.g., a noise or interference portion) of a voice signal. In addition, the electronic device and the method according to embodiments of the present disclosure may reduce energy loss of a specific band (e.g., a low frequency band) of the voice signal, thereby obtaining clearer voice.

FIG. 9 illustrates an example of an operation flow for a method of obtaining a signal in which a noise is suppressed via an embedding layer and a neural network.

The method of FIG. 9 may be performed by the wearable device 290 of FIG. 3 (or the wearable device 290 of FIG. 5, the wearable device 290 of FIGS. 2A and 2B, or the electronic device 101 of FIG. 1). For example, at least one operation of the method may be controlled by a processor 320. For example, the neural network may include the neural network 400 of FIGS. 4 and 5. For example, the embedding layer may include the embedding layer 440 of FIGS. 4 and 5.

In operation 900, the wearable device 290 may obtain a first voice signal, a second voice signal, and a third voice signal. According to an embodiment, the wearable device 290 may obtain a plurality of voice signals via a plurality of microphones and a sensor. For example, each of the plurality of voice signals may indicate a signal including voice uttered by a user of the wearable device 290. For example, the plurality of voice signals may include the first voice signal, the second voice signal, and the third voice signal. For example, the wearable device 290 may obtain the first voice signal using an outer microphone (e.g., the outer microphone 340 of FIG. 3). In addition, the wearable device 290 may obtain the second voice signal using an inner microphone (e.g., the inner microphone 350 of FIG. 3). In addition, the wearable device 290 may obtain the third voice signal using the sensor (e.g., the sensor 360 of FIG. 3). The outer microphone and the inner microphone may be included in the plurality of microphones.

In operation 910, the wearable device 290 may obtain first feature values based on the first voice signal. According to an embodiment, the wearable device 290 may obtain the first feature values from the first voice signal based on at least a portion of layers of the neural network. For example, the at least a portion of layers of the neural network may include layers for processing the first voice signal. For example, the at least a portion of layers may include the encoding layers of the encoder 410 of FIG. 4. The first feature values may indicate a feature value indicating a voice portion of the first voice signal.

In operation 920, the wearable device 290 may obtain second feature values based on at least one voice signal. According to an embodiment, the wearable device 290 may obtain the second feature values from the at least one voice signal based on an embedding layer connected to a specific layer of the neural network. For example, the specific layer may indicate a layer connected to an output layer of the at least a portion of layers. For example, the specific layer may include the bottleneck layer 430 connected to the encoding layers of the encoder 410 of FIG. 4. For example, the at least one voice signal may be identified based on a quality of the first voice signal from among the first voice signal, the second voice signal, and the third voice signal. For specific content related to this, the method of FIG. 7A described above may be referenced.

According to an embodiment, the wearable device 290 may perform a preprocessing based on the identified at least one voice signal. For example, the preprocessing (or a processing) may include at least one from among a filtering, a Fourier transform, a cancellation of a component in a specific frequency band, or a feature extraction (e.g., a feature extraction algorithm or a feature extraction scheme), for the identified at least one voice signal. The wearable device 290 may obtain a feature vector from the at least one voice signal based on performing the preprocessing. For specific content related to this, the method of FIG. 7B described above may be referenced.

According to an embodiment, the wearable device 290 may obtain the second feature values from the feature vector based on the encoding layer. For example, the second feature values may indicate feature values for a voice portion of the at least one voice signal.

In operation 930, the wearable device 290 may obtain the signal in which the noise is suppressed. According to an embodiment, the wearable device 290 may obtain the signal in which the noise is suppressed (or cancelled) (or the voice portion is enhanced) from the first feature values and the second feature values based on at least another portion of layers of the neural network. For example, the first feature values may indicate a feature value extracted with respect to a voice portion of the first voice signal. The second feature values may indicate a feature value extracted with respect to a voice portion of the at least one voice signal. For example, the at least another portion of layers of the neural network may include layers for generating an output signal of the neural network. For example, the at least another portion of layers may include the decoding layers of the decoder 420 of FIG. 4. The signal in which the noise is suppressed may be used to provide a service for recognizing (or a service for registering) an utterer uttering the first voice signal (or the voice portion).

Although not illustrated in FIG. 9, according to an embodiment, the neural network and the embedding layer may be in a trained state before performing the operation 900. For example, the neural network and the embedding layer may be in a trained state based on a speech signal and a noisy signal. For specific content related to this, the methods of FIG. 5 described above may be referenced.

In addition, although not illustrated in FIG. 9, according to an embodiment, the wearable device 290 may identify the neural network and the embedding layer. For example, the wearable device 290 may identify the neural network and the embedding layer for a speech enhancement scheme for obtaining the signal in which the noise is suppressed.

As described above, a wearable device 290 may include memory 330 including one or more storage media storing instructions. The wearable device 290 may include a plurality of microphones 340 and 350. The wearable device 290 may include an accelerometer 360. The wearable device 290 may include at least one processor 320 comprising processing circuitry. The instructions, when executed by the at least one processor 320 individually or collectively, may cause the wearable device 290 to, based on encoding layers of a neural network 400, obtain first feature values from a first voice signal obtained via an outer microphone 340 of the plurality of microphones 340 and 350. The instructions, when executed by the at least one processor 320 individually or collectively, may cause the wearable device 290 to, based on an embedding layer 440 connected to a bottleneck layer of the neural network 400, obtain second feature values from at least one voice signal from among the first voice signal, a second voice signal obtained via an inner microphone 350 of the plurality of microphones, and a third voice signal obtained via the accelerometer 360. The at least one voice signal may be identified based on a signal to noise ratio (SNR) of the first voice signal. The instructions, when executed by the at least one processor 320 individually or collectively, may cause the wearable device 290 to, based on decoding layers of the neural network 400, obtain a signal in which a noise is suppressed from the first feature values and the second feature values.

According to an embodiment, the instructions, when executed by the at least one processor 320 individually or collectively, may cause the wearable device 290 to obtain the first voice signal from the outer microphone 340. The instructions, when executed by the at least one processor 320 individually or collectively, may cause the wearable device 290 to obtain the second voice signal from the inner microphone 350. The instructions, when executed by the at least one processor 320 individually or collectively, may cause the wearable device 290 to obtain the third voice signal from the accelerometer 360. The third voice signal may include information on a vibration obtained, in a state in which the wearable device 290 is worn at a body portion of a user, from the body portion.

According to an embodiment, the instructions, when executed by the at least one processor 320 individually or collectively, may cause the wearable device 290 to identify the SNR of the first voice signal. The instructions, when executed by the at least one processor 320 individually or collectively, may cause the wearable device 290 to, based on identifying that the SNR of the first voice signal is less than a first reference level, identify the third voice signal as the at least one voice signal. The instructions, when executed by the at least one processor 320 individually or collectively, may cause the wearable device 290 to, based on identifying that the SNR of the first voice signal is more than or equal to the first reference level and less than a second reference level higher than the first reference level, identify the second voice signal and the third voice signal as the at least one voice signal. The instructions, when executed by the at least one processor 320 individually or collectively, may cause the wearable device 290 to, based on identifying that the SNR of the first voice signal is more than or equal to the second reference level, identify the first voice signal as the at least one voice signal.

According to an embodiment, a bandwidth of the first voice signal and the second voice signal used as the at least one voice signal, may be adjusted to correspond to a bandwidth of the third voice signal. The second feature values may be identified based on at least one from among the adjusted first voice signal, the adjusted second voice signal, or the second voice signal.

According to an embodiment, the instructions, when executed by the at least one processor 320 individually or collectively, may cause the wearable device 290 to, based on the encoding layer 440, obtain the first feature values using a signal Fourier transformed from the first voice signal.

According to an embodiment, the instructions, when executed by the at least one processor 320 individually or collectively, may cause the wearable device 290 to, based on a processing performed with respect to the at least one voice signal, obtain the second feature values. The processing may include at least one from among a filtering, a Fourier transform, a cancellation of a signal of a specific frequency band in the at least one voice signal, or a feature extraction.

According to an embodiment, the neural network 400 may be trained based on a difference between a speech signal and an output signal obtained, based on the neural network 400, from a noisy signal including the speech signal obtained via the plurality of microphones 340 and 350 and a noise signal. The embedding layer 440 may be trained based on the difference.

According to an embodiment, the first feature values may indicate a feature value extracted with respect to a voice portion of the first voice signal. The second feature values may indicate a feature value extracted with respect to a voice portion of the at least one voice signal.

According to an embodiment, the outer microphone 340 may include at least one microphone to obtain the first voice signal, in a state in which the wearable device 290 is worn at a body portion of a user, from a second direction different from a first direction toward the body portion. The inner microphone 350 may include at least one another microphone to obtain the second voice signal, in a state in which the wearable device 290 is worn at the body portion of the user, from the first direction.

According to an embodiment, a bandwidth of the third voice signal may be narrower than a bandwidth of the first voice signal or a bandwidth of the second voice signal.

According to an embodiment, the bottleneck layer may indicate a layer having the smallest size from among a plurality of layers of the neural network 400.

According to an embodiment, size of an output layer of the embedding layer 440 may correspond to size of the bottleneck layer.

According to an embodiment, a signal in which the noise is suppressed may be used to provide a service for recognizing an utterer uttering the first voice signal.

As described above, a method executed by a wearable device 290 may include, based on encoding layers of a neural network 400, obtaining first feature values from a first voice signal obtained via an outer microphone 340 of a plurality of microphones 340 and 350. The method may include, based on an embedding layer 440 connected to a bottleneck layer of the neural network 400, obtaining second feature values from at least one voice signal from among the first voice signal, a second voice signal obtained via an inner microphone 350 of the plurality of microphones, and a third voice signal obtained via an accelerometer 360. The at least one voice signal may be identified based on a signal to noise ratio (SNR) of the first voice signal. The method may include, based on decoding layers of the neural network 400, obtaining a signal in which a noise is suppressed from the first feature values and the second feature values.

As described above, a non-transitory computer readable storage medium may store one or more programs including instructions, when executed by at least one processor 320 of a wearable device 290 including a plurality of microphones 340 and 350 and an accelerometer 360 individually or collectively, cause to, based on encoding layers of a neural network 400, obtain first feature values from a first voice signal obtained via an outer microphone 340 of the plurality of microphones 340 and 350. The non-transitory computer readable storage medium may store the one or more programs including the instructions, when executed by the at least one processor 320 individually or collectively, cause to, based on an embedding layer 440 connected to a bottleneck layer of the neural network 400, obtain second feature values from at least one voice signal from among the first voice signal, a second voice signal obtained via an inner microphone 350 of the plurality of microphones, and a third voice signal obtained via the accelerometer 360. The at least one voice signal may be identified based on a signal to noise ratio (SNR) of the first voice signal. The non-transitory computer readable storage medium may store the one or more programs including the instructions, when executed by the at least one processor 320 individually or collectively, cause to, based on decoding layers of the neural network 400, obtain a signal in which a noise is suppressed from the first feature values and the second feature values.

As described above, a wearable device 290 may include a plurality of microphones 340 and 350. The wearable device 290 may include a sensor 360. The wearable device 290 may include a processor 320. The processor 320 may be configured to, based on first layers from among a plurality of layers of a neural network 400, obtain first feature values from a first voice signal obtained via an outer microphone 340 of the plurality of microphones 340 and 350. The processor 320 may be configured to, based on at least one second layer 440 including a second output layer connected to a first output layer of the first layers, obtain second feature values from at least one voice signal from among the first voice signal, a second voice signal obtained via an inner microphone 350 of the plurality of microphones 340 and 350, and a third voice signal obtained via the sensor. The at least one voice signal may be identified based on a quality of the first voice signal. The processor 320 may be configured to, based on third layers including an input layer connected to the first output layer among the plurality of layers, obtain a signal in which a noise is suppressed from the first feature values and the second feature values.

According to an embodiment, the processor 320 may be configured to obtain the first voice signal from the outer microphone 340. The processor 320 may be configured to obtain the second voice signal from the inner microphone 350. The processor 320 may be configured to obtain the third voice signal from the sensor 360. The third voice signal may include information on a vibration obtained, in a state in which the wearable device 290 is worn at a body portion of a user, from the body portion.

According to an embodiment, the processor 320 may be configured to identify the quality of the first voice signal. The processor 320 may be configured to, based on identifying that the quality of the first voice signal is less than a first reference level, identify the third voice signal as the at least one voice signal. The processor 320 may be configured to, based on identifying that the quality of the first voice signal is more than or equal to the first reference level and less than a second reference level higher than the first reference level, identify the second voice signal and the third voice signal as the at least one voice signal. The processor 320 may be configured to, based on identifying that the quality of the first voice signal is more than or equal to the second reference level, identify the first voice signal as the at least one voice signal.

According to an embodiment, the processor 320 may be configured to, based on the at least one second layer 440, obtain the first feature values using a signal Fourier transformed from the first voice signal. The processor 320 may be configured to, based on a processing performed with respect to the at least one voice signal, obtain the second feature values. The processing may include at least one from among a filtering, a Fourier transform, a cancellation of a signal of a specific frequency band in the at least one voice signal, or a feature extraction.

According to an embodiment, the first feature values may indicate a feature value extracted with respect to a voice portion of the first voice signal. The second feature values may indicate a feature value extracted with respect to a voice portion of the at least one voice signal.

According to an embodiment, the outer microphone 340 may include at least one microphone to obtain the first voice signal, in a state in which the wearable device 290 is worn at a body portion of a user, from a second direction different from a first direction toward the body portion. The inner microphone 350 may include at least one another microphone to obtain the second voice signal, in a state in which the wearable device 290 is worn at the body portion of the user, from the first direction.

According to an embodiment, size of the first output layer may correspond to size of the second output layer.

As described above, a method executed by a wearable device 290 may include, based on first layers from among a plurality of layers of a neural network 400, obtaining first feature values from a first voice signal obtained via an outer microphone 340 of a plurality of microphones 340 and 350. The method may include, based on at least one second layer 440 including a second output layer connected to a first output layer of the first layers, obtaining second feature values from at least one voice signal from among the first voice signal, a second voice signal obtained via an inner microphone 350 of the plurality of microphones 340 and 350, and a third voice signal obtained via the sensor. The at least one voice signal may be identified based on a quality of the first voice signal. The method may include, based on third layers including an input layer connected to the first output layer among the plurality of layers, obtaining a signal in which a noise is suppressed from the first feature values and the second feature values.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 240) including one or more instructions that are stored in a storage medium (e.g., internal memory 236 or external memory 238) that is readable by a machine (e.g., the electronic device 201). For example, a processor (e.g., the processor 220) of the machine (e.g., the electronic device 201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable device comprising:
memory comprising one or more storage media storing instructions;
a plurality of microphones;
an accelerometer;
at least one processor comprising processing circuitry,
wherein the instructions, when executed by the at least one processor individually or collectively, cause the wearable device to:
based on encoding layers of a neural network, obtain first feature values from a first voice signal obtained via an outer microphone of the plurality of microphones;
based on an embedding layer connected to a bottleneck layer of the neural network, obtain second feature values from at least one voice signal from among the first voice signal, a second voice signal obtained via an inner microphone of the plurality of microphones, and a third voice signal obtained via the accelerometer, wherein the at least one voice signal is identified based on a signal to noise ratio (SNR) of the first voice signal; and
based on decoding layers of the neural network, obtain a signal in which a noise is suppressed from the first feature values and the second feature values.

2. The wearable device of claim 1,
wherein the instructions, when executed by the at least one processor individually or collectively, cause the wearable device to:
obtain the first voice signal from the outer microphone;
obtain the second voice signal from the inner microphone; and
obtain the third voice signal from the accelerometer,
wherein the third voice signal includes information on a vibration obtained, in a state in which the wearable device is worn at a body portion of a user, from the body portion.

3. The wearable device of claim 2,
wherein the instructions, when executed by the at least one processor individually or collectively, cause the wearable device to:
identify the SNR of the first voice signal;
based on identifying that the SNR of the first voice signal is less than a first reference level, identify the third voice signal as the at least one voice signal;
based on identifying that the SNR of the first voice signal is more than or equal to the first reference level and less than a second reference level higher than the first reference level, identify the second voice signal and the third voice signal as the at least one voice signal; and
based on identifying that the SNR of the first voice signal is more than or equal to the second reference level, identify the first voice signal as the at least one voice signal.

4. The wearable device of claim 3,
wherein a bandwidth of the first voice signal and the second voice signal used as the at least one voice signal, is adjusted to correspond to a bandwidth of the third voice signal, and
wherein the second feature values are identified based on at least one from among an adjusted first voice signal, an adjusted second voice signal, or the second voice signal.

5. The wearable device of claim 1,
wherein the instructions, when executed by the at least one processor individually or collectively, cause the wearable device to:
based on the encoding layers, obtain the first feature values using a signal Fourier transformed from the first voice signal.

6. The wearable device of claim 1,
wherein the instructions, when executed by the at least one processor individually or collectively, cause the wearable device to:
based on a processing performed with respect to the at least one voice signal, obtain the second feature values,
wherein the processing includes at least one from among a filtering, a Fourier transform, a cancellation of a signal of a specific frequency band in the at least one voice signal, or a feature extraction.

7. The wearable device of claim 1,
wherein the neural network is trained based on a difference between a speech signal and an output signal obtained, based on the neural network, from a noisy signal including the speech signal obtained via the plurality of microphones and a noise signal, and
wherein the embedding layer is trained based on the difference.

8. The wearable device of claim 1,
wherein the first feature values indicate a feature value extracted with respect to a voice portion of the first voice signal, and
wherein the second feature values indicate a feature value extracted with respect to a voice portion of the at least one voice signal.

9. The wearable device of claim 1,
wherein the outer microphone includes at least one microphone to obtain the first voice signal, in a state in which the wearable device is worn at a body portion of a user, from a second direction different from a first direction toward the body portion, and
wherein the inner microphone includes at least one another microphone to obtain the second voice signal, in a state in which the wearable device is worn at the body portion of the user, from the first direction.

10. The wearable device of claim 1,
wherein a bandwidth of the third voice signal is narrower than a bandwidth of the first voice signal or a bandwidth of the second voice signal.

11. The wearable device of claim 1,
wherein the bottleneck layer indicates a layer having smallest size from among a plurality of layers of the neural network.

12. The wearable device of claim 1,
wherein a size of an output layer of the embedding layer corresponds to a size of the bottleneck layer.

13. The wearable device of claim 1,
wherein a signal in which the noise is suppressed is used to provide a service for recognizing an utterer uttering the first voice signal.

14. A method executed by a wearable device, the method comprising:
based on encoding layers of a neural network, obtaining first feature values from a first voice signal obtained via an outer microphone of a plurality of microphones of the wearable device;
based on an embedding layer connected to a bottleneck layer of the neural network, obtaining second feature values from at least one voice signal from among the first voice signal, a second voice signal obtained via an inner microphone of the plurality of microphones, and a third voice signal obtained via an accelerometer of the wearable device, wherein the at least one voice signal is identified based on a signal to noise ratio (SNR) of the first voice signal; and
based on decoding layers of the neural network, obtaining a signal in which a noise is suppressed from the first feature values and the second feature values.

15. The method of claim 14, further comprising:
obtaining the first voice signal from the outer microphone;
obtaining the second voice signal from the inner microphone; and
obtaining the third voice signal from the accelerometer,
wherein the third voice signal includes information on a vibration obtained, in a state in which the wearable device is worn at a body portion of a user, from the body portion.

16. The method of claim 15, further comprising:
identifying the SNR of the first voice signal;
based on identifying that the SNR of the first voice signal is less than a first reference level, identifying the third voice signal as the at least one voice signal;
based on identifying that the SNR of the first voice signal is more than or equal to the first reference level and less than a second reference level higher than the first reference level, identifying the second voice signal and the third voice signal as the at least one voice signal; and
based on identifying that the SNR of the first voice signal is more than or equal to the second reference level, identifying the first voice signal as the at least one voice signal.

17. The method of claim 16,
wherein a bandwidth of the first voice signal and the second voice signal used as the at least one voice signal, is adjusted to correspond to a bandwidth of the third voice signal, and
the second feature values are identified based on at least one from among an adjusted first voice signal, an adjusted second voice signal, or the second voice signal.

18. The method of claim 14, further comprising:
based on the encoding layers, obtaining the first feature values using a signal Fourier transformed from the first voice signal.

19. The method of claim 14,
based on a processing performed with respect to the at least one voice signal, obtaining the second feature values,
wherein the processing includes at least one from among a filtering, a Fourier transform, a cancellation of a signal of a specific frequency band in the at least one voice signal, or a feature extraction.

20. A non-transitory computer readable storage medium storing one or more programs, the one or more programs comprising instructions, when executed by at least one processor of a wearable device comprising a plurality of microphones and an accelerometer, cause the wearable device to:
based on encoding layers of a neural network, obtain first feature values from a first voice signal obtained via an outer microphone of the plurality of microphones;
based on an embedding layer connected to a bottleneck layer of the neural network, obtain second feature values from at least one voice signal from among the first voice signal, a second voice signal obtained via an inner microphone of the plurality of microphones, and a third voice signal obtained via the accelerometer, wherein the at least one voice signal is identified based on a signal to noise ratio (SNR) of the first voice signal; and
based on decoding layers of the neural network, obtain a signal in which a noise is suppressed from the first feature values and the second feature values.
